(19) United States
(12) Patent Application Publication
(10) Pub. No.: US 2008/0037878 A1
(43) Pub. Date: Feb. 14, 2008

(54) Information processing apparatus, information processing method, computer readable medium and data signal

(75) Inventor: Hitoshi Katta, Kanagawa (JP)

Correspondence Address: SUGHRUE-265550, 2100 PENNSYLVANIA AVE. NW, WASHINGTON, DC, 20037-3213, US

(73) Assignee: FUJI XEROX CO., LTD., Tokyo (JP)

(21) Appl. No.: 11/640,203

(22) Filed: Dec. 18, 2006

(30) Foreign Application Priority Data
Aug. 8, 2006 (JP) 2006-215202

(51) Int. Cl. G06K 9/62

(52) U.S. Cl. 382/224

(57) ABSTRACT

An information processing apparatus for displaying a list of pieces of image data, includes a data processing section, a display information generating section and a display section. The data processing section classifies the pieces of image data, which are to be displayed in the list, into image groups based on information contained in the respective pieces of image data. The display information generating section generates display information, which represents a list including a representative image of each image group, based on a result of the classification by the data processing section. The display section outputs the display information generated by the display information generating section.

### BACKGROUND

### Technical Field

The invention relates to an information processing apparatus, an information processing method, a computer readable medium and a data signal. Particularly, the invention relates to an information processing apparatus, an information processing method, a computer readable medium and a data signal for performing display in such a manner that efficient image retrieval can be achieved in a configuration in which a list of photographs, for example, taken in a digital camera etc., are displayed.

### SUMMARY

According to an aspect of the invention, an information processing apparatus for displaying a list of pieces of image data, includes a data processing section, a display information generating section and a display section. The data processing section classifies the pieces of image data, which are to be displayed in the list, into image groups based on information contained in the respective pieces of image data. The display information generating section generates display information, which represents a list including a representative image of each image group, based on a result of the classification by the data processing section. The display section outputs the display information generated by the display information generating section.

### BRIEF DESCRIPTION OF THE DRAWINGS

Exemplary embodiments of the invention will be described in detail below with reference to accompanying drawings wherein:

FIG. 1 is a view for explaining a use example of each information processing apparatus according to an exemplary embodiment of the invention;

FIG. 2 is a block diagram showing the configuration of the information processing apparatus according to the exemplary embodiment of the invention;

FIG. 3 is a view showing a configuration example of an image data file;

FIG. 4 is a view for explaining a data sorting process example;

FIGS. 5(1) and 5(2) are views for explaining data display examples;

FIG. 6 is a view for explaining an image list display example;

FIG. 7 is a view for explaining image list display and a processing example to be performed by a user;

FIG. 8 is a view for explaining image list display and a processing example to be performed by a user;

FIG. 9 is a view for explaining image list display and a processing example to be performed by a user;

FIG. 10 is a flow chart for explaining a processing sequence in the information processing apparatus according to the exemplary embodiment of the invention; and

FIG. 11 is a view for explaining a hardware configuration example of the information processing apparatus according to the exemplary embodiment of the invention.

### DETAILED DESCRIPTION

An information processing apparatus, an information processing method, a computer readable medium and a data signal according to exemplary embodiments of the invention will be described below in detail with reference to the drawings.

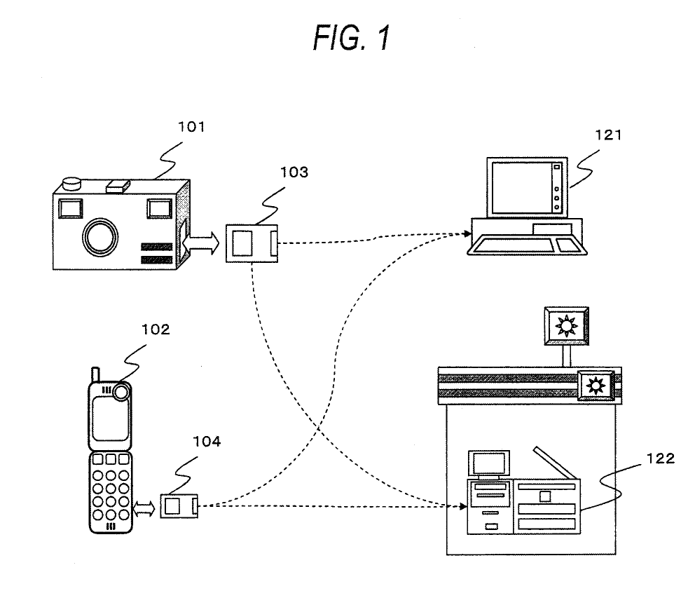

FIG. 1 is a view for explaining a use mode of each information processing apparatus according to the exemplary embodiment of the invention. In FIG. 1, the information processing apparatuses according to the exemplary embodiment of the invention are an information processing apparatus (PC) 121 and an information processing apparatus 122, which is a print service terminal installed in a convenience store. These information processing apparatuses 121 and 122 displays image data, which are, for example, captured by a digital camera 3 101 or a mobile phone 102 and recorded in a recording medium 103 or 104 such as a flash memory, as a list on a display. An example of the data displayed as a list is a list of reduced images (thumbnail images).

For example, each of the information processing apparatuses 121 and 122 has media slots for setting the recording media 103 and 104 and executes a process for reading the image data recorded in the recording media and displaying the list of image data on the display. Each of the information processing apparatuses 121 and 122 sets photographs regarded as being captured continuously for substantially the same scene as one group in the list display process and collects a group of photographs as one bundle. When the bundle is judged to be a bundle for substantially the same scene, one photograph in the bundle is displayed as a representative photograph of the scene. In the display process, one photograph as a representative photograph of a bundle and one single photograph not set as a bundle are displayed in different presentation forms so as to be distinguishable from each other.

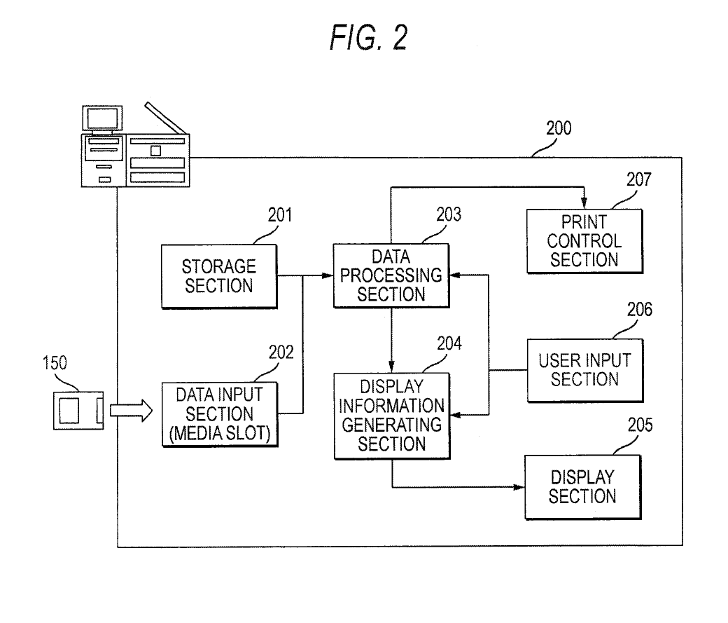

A specific processing example to be executed by the information processing apparatus according to the exemplary embodiment of the invention will be described below with reference to FIG. 2. FIG. 2 is a block diagram showing the configuration of an information processing apparatus 200 according to the exemplary embodiment of the invention. As shown in FIG. 2, the information processing apparatus 200 has a storage section 201, a data input section (media slot) 202, a data processing section 203, a display information generating section 204, a display section 205, a user input section 206, and a print control section 207.

The storage section 201 is a storage section such as a hard disk, an ROM or an RAM. The storage section 201 includes a storage area for storing a program for executing data processing, and a storage area such as a work area for executing the data processing. Image data to be displayed as a list can be also stored in the storage section 201. The data input section (media slot) 202 reads data from a recording medium (media) 150 in which data such as photographic images captured by a digital camera, a mobile phone, etc. are recorded.

The data processing section 203 executes a process for classifying the image data read from the recording medium (media) 150 set in the data input section (media slot) 202. That is, the data processing section 203 classifies plural images (photographs) to be displayed as a list, prior to the process for displaying list display data as thumbnail images on the display section 205. Incidentally, the data processing section 203 may process not only the image data read from the recording medium (media) 150 but also input image data stored in advance in the storage section 201.

The data processing section 203 executes a judgment process as to whether each of the plural images (photographs) to be applied to a list display process is included in a group of photographs for one and the same scene. Specifically, a judgment process as to whether the image is a similar image or not, is performed based on analysis of attribute information set in a recording data file (e.g. Exif file) of each photograph, specifically, nearness in photographing dates and times included in the attribute information, similarity in photographing conditions (exposure conditions, focal lengths, etc.) included in the attribute information, or image analysis. A specific example of the Exif file will be described later.

The display information generating section 204 generates data for displaying a list of thumbnail images in accordance with the classification result by the data processing section 203. In order to explicitly indicate the fact that the photograph displayed as a representative photograph of the scene is included in a bundle of photographs, the display information generating section 204 sets a display mode for outputting the representative photograph of the scene to the display section 205 to be different from the display mode for outputting a single photograph. For example, the display information generating section may set the display mode of the representative photograph to be a display mode for stacking images behind the representative photograph, a display mode for attaching a folder mark to the representative photograph, a display mode for surrounding the representative photograph by lines so as to indicate a group of photographs, or a display mode for displaying a specific background image.

Incidentally, the data processing section 203 and the display information generating section 204 execute processes corresponding to user's inputs, for example, based on various instruction information input from the user input section 206 such as a display information switching instruction or a print instruction.

The display section 205 is a display such as an LCD for displaying the display data generated by the display information generating section 204, that is, for displaying an image list of thumbnail images. The user input section 206 allows a user to input information about selection of an image to be printed, display switching and/or print execution. Incidentally, the user input section 206 may be configured as a system which detects user's input on the display section 205 when the display section 205 is provided as a touch display. The print control section 207 controls a printer (not shown) so as to execute a print process based on instruction information from the data processing section 203.

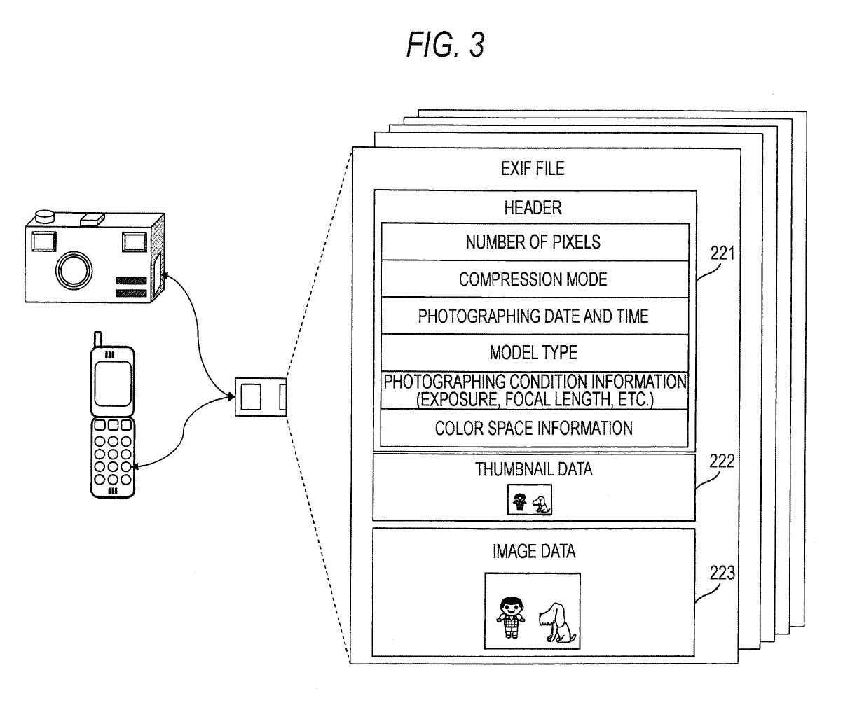

Description will be given on a configuration example of image data to be processed in the information processing apparatus according to the exemplary embodiment of the invention. FIG. 3 is a view showing an example of data configuration of a file recorded in a recoding medium. Each photograph is recorded as an Exif file having the data configuration shown in FIG. 3. The Exif file is set for each photograph data. As shown in FIG. 3, the Exif file has a header 221, thumbnail data 222 and image data 223.

The header 221 is an area where attribute information of the photograph is recorded. As shown in FIG. 3, the number of pixels, a compression mode, photographing date and time, a model type, photographing condition information such as exposure and focal length, color space information, etc. are recorded in the header 221. The thumbnail data 222 is an area where reduced image data is recorded. The thumbnail data is used in a process for displaying a list of images. The image data 223 is an area where actual captured image data is recorded.

To perform a data classification process, the data processing section 203 shown in FIG. 2 analyzes each image data file shown in FIG. 3. That is, the data processing section 203 judges whether or not plural pieces of image are similar images, based on nearness in photographing dates and times set in Exif files, similarity in photographing conditions (exposure conditions, focal lengths, etc.), and/or image analysis.

When, for example, the data processing section 203 performs the data classification process based on nearness among photographing dates and times set in Exif files, the data processing section 203 uses a predetermined threshold time T stored in the storage section 201. After the data processing section 203 acquires the photographing date and time information set in files corresponding to photographs to be displayed as a list, the data processing section 203 sets plural photographs among which differences in date and time are within the threshold time T, as one group (bundle).

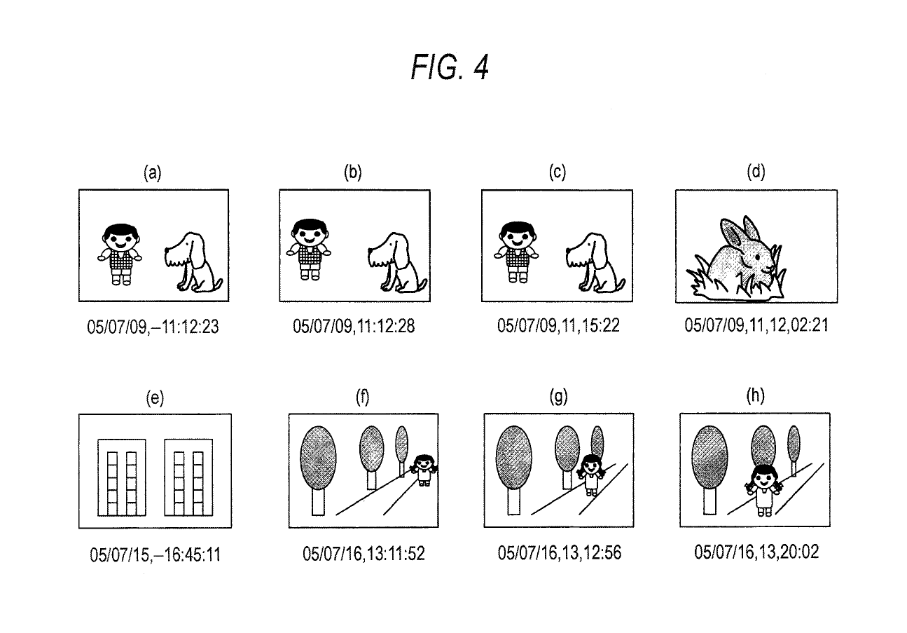

A specific example of the classification process will be described with reference to FIG. 4. FIG. 4 shows eight images, i.e. images (a) to (h). Photographing date and time information is set as attribute information of each of the images (a) to (h). To execute the data classification process based on nearness in photographing dates and times set in image data files (Exif files), the data processing section 203 judges whether or not a difference between photographing dates and times of adjacent files is within the threshold time T. For example, it is assumed that the threshold time T is 2 hours.

The data processing section 203 identifies the photographing date and time of each photograph shown in FIG. 4 as follows based on the attribute information set in each file.
(a) Photographing date and time: Jul. 9, 2005 11:12:23
(b) Photographing date and time: Jul. 9, 2005 11:12:28
(c) Photographing date and time: Jul. 9, 2005 11:15:22
(d) Photographing date and time: Jul. 11, 2005 12:02:21
(e) Photographing date and time: Jul. 15, 2005 16:45:11
(f) Photographing date and time: Jul. 16, 2005 13:11:52
(g) Photographing date and time: Jul. 16, 2005 13:12:56
(h) Photographing date and time: Jul. 16, 2005 13:20:02

The data processing section 203 performs verification by comparing the time interval between the photographing dates and times of adjacent ones of the paragraphs (a) to (h) with the threshold T (2 hours).
Time interval between (a) and (b)=5 sec≦2 hours (T)
Time interval between (b) and (c)=2 min 54 sec≦2 hours (T)
Time interval between (c) and (d)=2 days 46 min 59 sec>2 hours (T)
Time interval between (d) and (e)=4 days 4 hours 42 min 50 sec>2 hours (T)
Time interval between (e) and (f)=20 hours 26 min 41 sec>2 hours (T)
Time interval between (f) and (g)=1 min 4 sec≦2 hours (T)
Time interval between (g) and (h)=7 min 6 sec≦2 hours (T)

Results of the differences between the photographing dates and times of the photographs are shown as above. On the assumption that the threshold time (T) is 2 hours, the time interval between (a) and (b) and the time interval between (b) and (c) are not larger than the threshold time, so that the data processing section 203 sets the photographs (a) to (c) as a group (bundle). In this case, in the photograph list display, only one of the photographs (a) to (c) is selected as a representative photograph and used in the list display. As a method for selecting the representative photograph in this case, various settings may be performed. For example, the first one of the photographs in terms of photographing date and time may be set as the representative photograph, the last one of the photographs in terms of photographing date and time may be set as the representative photograph, or the intermediate one of the photographs in terms of photographing date and time may be set as the representative photograph.

Because the time interval between (c) and (d) is larger than the threshold time, the data processing section 203 judges that the photograph (d) is not included in the group of photographs (a) to (c). Because the time interval between (d) and (e) is larger than the threshold time, the data processing section 203 judges that the photograph (d) belongs to another photograph group rather than the photograph (e). In this case, the photograph (d) is displayed as a single photograph in the list. Similarly, the time interval between (e) and (f) is larger than the threshold time, so that the photograph (e) is displayed as a single photograph in the list.

The time interval between (f) and (g) and the time interval between (g) and (h) are not larger than the threshold time, so that the data processing section 203 judges that the photographs (f) to (h) belong to the same group (bundle). In this case, in the photograph list display, only one of the photographs (f) to (h) is selected as a representative photograph and used in the list display.

The data processing section 203 executes the data classification process based on nearness in photographing dates and times set in image data files (Exif files) as described above. Incidentally, as another classification method, the data processing section 203 may perform the data classification process for judging as to whether or not plural photographs are similar photographs based on similarity in photographing conditions (exposure conditions, focal lengths, etc.) included in the attribute information or based on image analysis. For example, similarity in the exposure conditions may be calculated by referring a value of EV recorded in the “ExposureBiasValue” tag of the Exif files. Also, similarity in the focal length may be calculated by referring a distance written in the “Focal Length” tag of the Exif files.

In the case where the data processing section 203 judges based on the similarity in the photographing conditions (exposure conditions, focal lengths, etc.), the storage section 201 stores thresholds of photographing conditions such as a difference threshold Ta in exposure conditions and a difference threshold Tb in focal lengths, etc. in advance. The data processing section 203 calculates differences between the photographing conditions (exposure conditions, focal lengths, etc.) extracted from the headers of taken photographs, compares the calculated differences with the respective thresholds and judges the plural photographs having differences within the thresholds as one group (bundle).

In the configuration where the data processing section 203 judges based on image analysis as to whether or not plural images are similar images, the data processing section 203 acquires image data of photographs, performs analysis on the image data by any of known methods, and judges similarity between image data. When, for example, similarity between images is not larger than a predetermined similarity judgment threshold, the data processing section 203 sets these images as one group (bundle) of images having high similarity.

As described above, the data processing section 203 judges similarity between photographs based on information obtained from image files and executes the data classification process on the photographs (classifies the photographs). The aforementioned processing example has been described as a processing example in which any one of the photographing dates and times, the photographing conditions and the images is used for judging similarity. Alternatively, the data processing section 203 may judge similarity by combination of the photographing dates and times, the photographing conditions and the images.

The display information generating section 204 generates display data of the images classified by the data processing section 203. That is, the display information generating section 204 generates list display data of the thumbnail images in accordance with the classification result by the data processing section 203. In order to explicitly indicate the fact that the photograph displayed as a representative photograph of the scene is included in a bundle of photographs, the display information generating section 204 sets a display mode for outputting the representative photograph of the scene to the display section 205 to be different from the display mode for outputting a single photograph. For example, the display information generating section may set the display mode of the representative photograph to be a display mode for stacking images behind the representative photograph, a display mode for attaching a folder mark to the representative photograph, a display mode for surrounding the representative photograph by lines so as to indicate a group of photographs, or a display mode for displaying a specific background image.

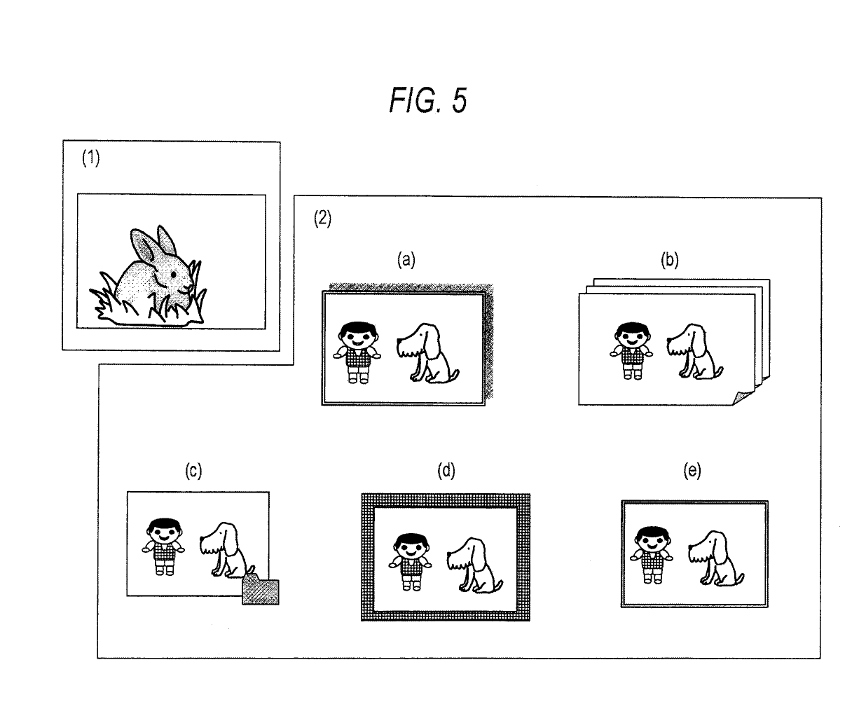

Display image examples generated by the display information generating section 204 will be described with reference to FIGS. 5(1) and 5(2). FIG. 5(1) shows a display mode for a single photograph. FIG. 5(2) shows display modes (a) to (e) each of which is different from the display mode for a single photograph in order to explicitly express a bundle of photographs.

The display mode (a) is an example explicitly indicating the bundle of photographs by shading.

The display mode (b) is an example explicitly indicating the bundle of photographs by arranging the images to be stacked up.

The display mode (c) is an example explicitly indicating the bundle of photographs by use of an indication of a folder.

The display mode (d) is an example explicitly indicating the bundle of photographs by setting the background with specific background data.

The display mode (e) is an example explicitly indicating the bundle of photographs by setting the frame as a specific frame (double line in the example shown in FIG. 5(2)).

As described above, when the display information generating section 204 generate the display data of the images classified by the data processing section 203, the display information generating section 204 sets a display mode for outputting the representative photograph of the scene to the display section 205 to be different from the display mode for outputting a single photograph in order to explicitly indicate the fact that the photograph displayed as a representative photograph of the scene is included in the bundle of photographs.

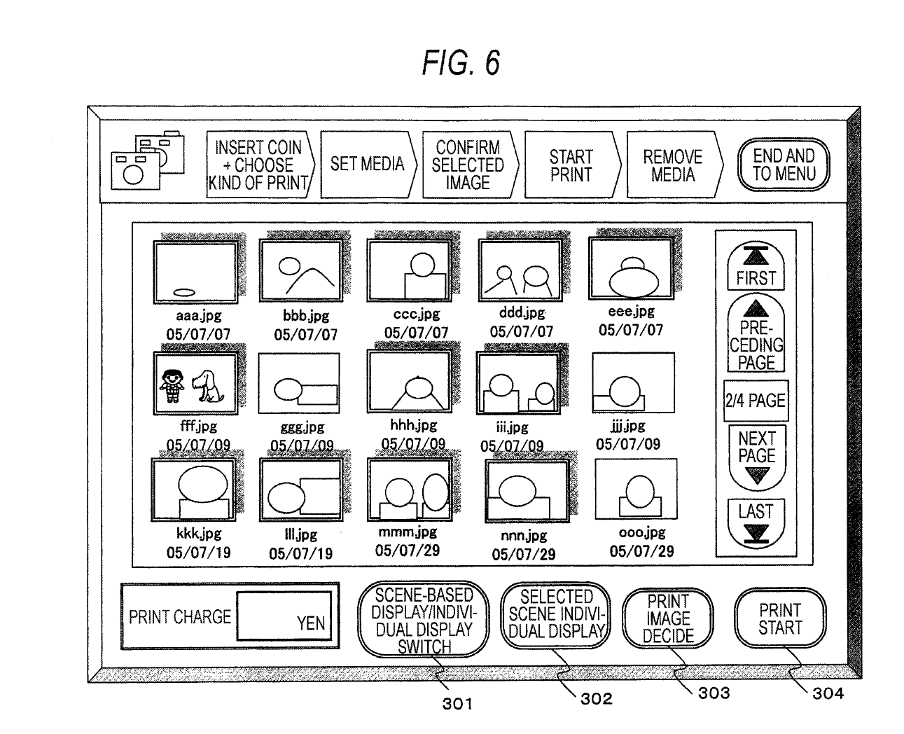

The display section 205 shown in FIG. 2 outputs display images generated by the display information generating section 204. A data display example is shown in FIG. 6. FIG. 6 shows an example in which pieces of photograph data read from the recording medium (media) set in the media slot 202 by a user are classified and displayed as a list on the display section 205 of the information processing apparatus 200, which is a print service terminal installed in a convenience store, etc.

In the example shown in FIG. 6, fifteen images “aaa.jpg” to “ooo.jpg” are displayed. The display page can be turned so that all images stored in the recording medium can be processed. The display images are reduced images (thumbnails). Of these images, images “aaa.jpg” to “fff.jpg” are displayed as shaded images. This indicates that each of images “aaa.jpg” to “fff.jpg” is a photograph (representative photograph) selected from a bundle of photographs of substantially the same scene.

An image “ggg.jpg” is an on-shaded image. This indicates that the image “ggg.jpg” is a single photograph, which does not belong to any group of photographs of substantially the same scene.

Images “hhh.jpg” and “iii.jpg” are displayed as shaded images. This indicates each of images “hhh.jpg” and “iii.jpg” is a photograph (representative photograph) selected from a bundle of photographs of substantially the same scene.

With respect to images “jjj.jpg” and subsequent images, display of thumbnail images is executed in the same manner as described above.

Incidentally, when the user operates a “scene-based display/individual display switch” button 301 shown in FIG. 6, which serves as a switching button, either scene-based display with scene sorting shown in FIG. 6 or individual photograph display without scene sorting can be displayed. In the individual photograph display process without scene sorting, the photograph classification process in the data processing section 203 is not executed but all the photographs are displayed individually.

A “selected scene individual display” button 302 shown in FIG. 6 is used for selecting a photograph group (bundle) with only its representative photograph of a scene being displayed and for displaying the selected bundle of photographs individually. This processing example will be described later. A “print image decide” button 303 is used for setting an image selected by the user as a print target. A “print start” button 304 is used for printing the selected image. The respective buttons 301 to 304 shown in FIG. 6 are equivalent to the user input section 206 shown in FIG. 2. These pieces of input information are input to the data processing section 203 and the display information generating section 204.

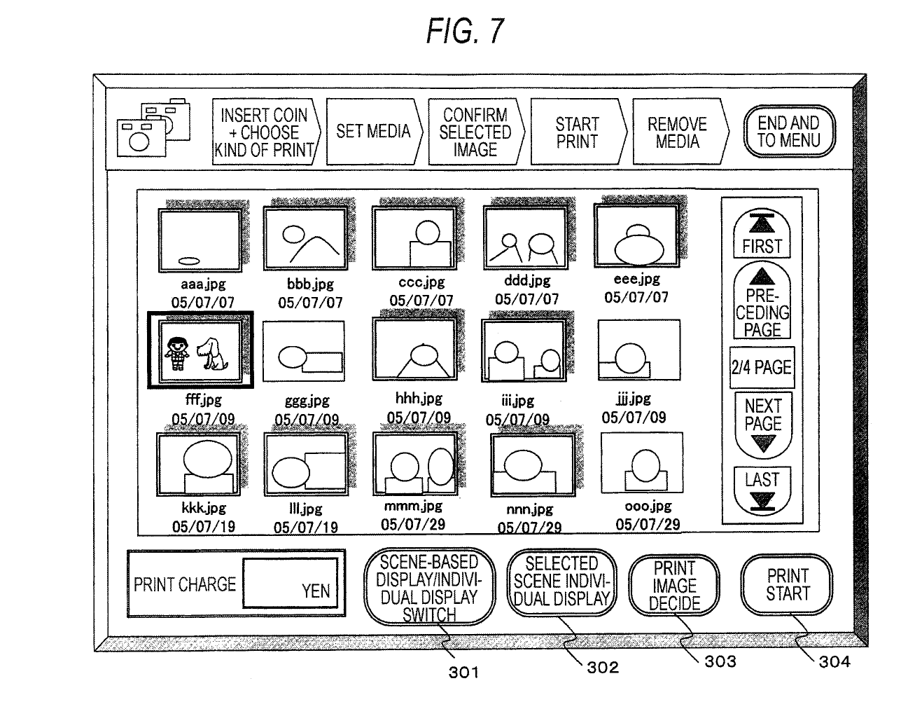

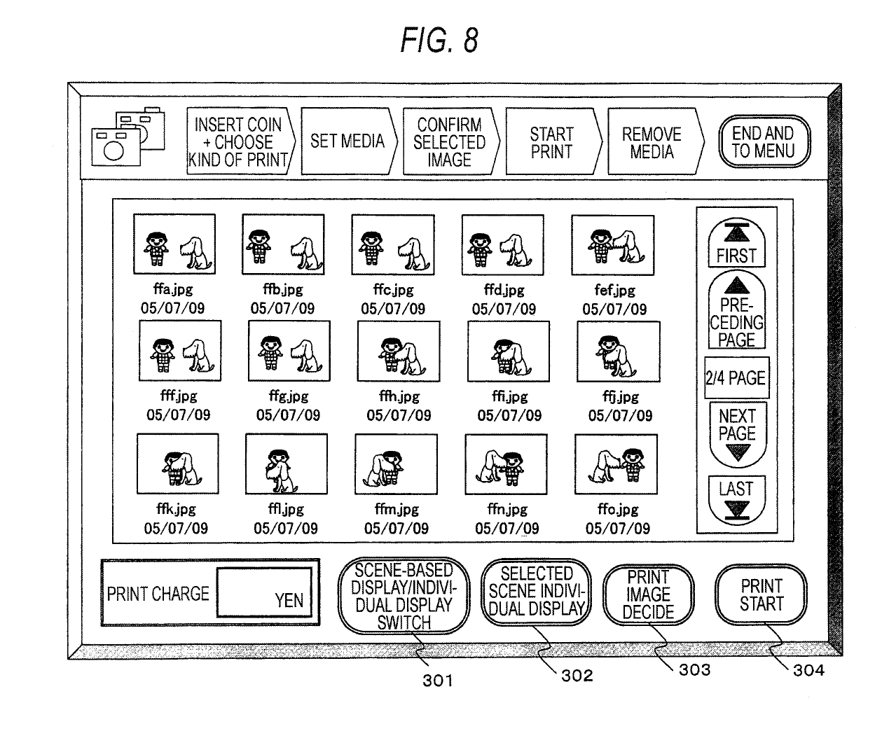

The user are allowed to select a photograph group (bundle) with only a representative photograph of a scene being displayed, and then the selected bundle of photographs are displayed individually. For execution of this process, the user operates the “selected scene individual display” button 302. When, for example, the user selects a group (bundle) “fff.jpg” at the left end of the middle row and operates the “selected scene individual display” button 302 as shown in FIG. 7, a list of individual photographs included in the group (bundle) “fff.jpg” are displayed as shown in FIG. 8. The display page can be turned so that all the images included in the group (bundle) “fff.jpg” can be displayed sequentially.

That is, the data processing section 203 shown in FIG. 2 acquires individual image data files included in the selected group in accordance with operation of the “selected scene individual display” button 302 on the display screen of the list display data, which is formed so that only one representative image selected for each image group is a subject of display as shown in FIG. 7. The display information generating section 204 generates an image list of individual images included in the selected group, i.e. a display list of individual photographs included in the group (bundle) “fff.jpg” as shown FIG. 8, and outputs the image list to the display section 205.

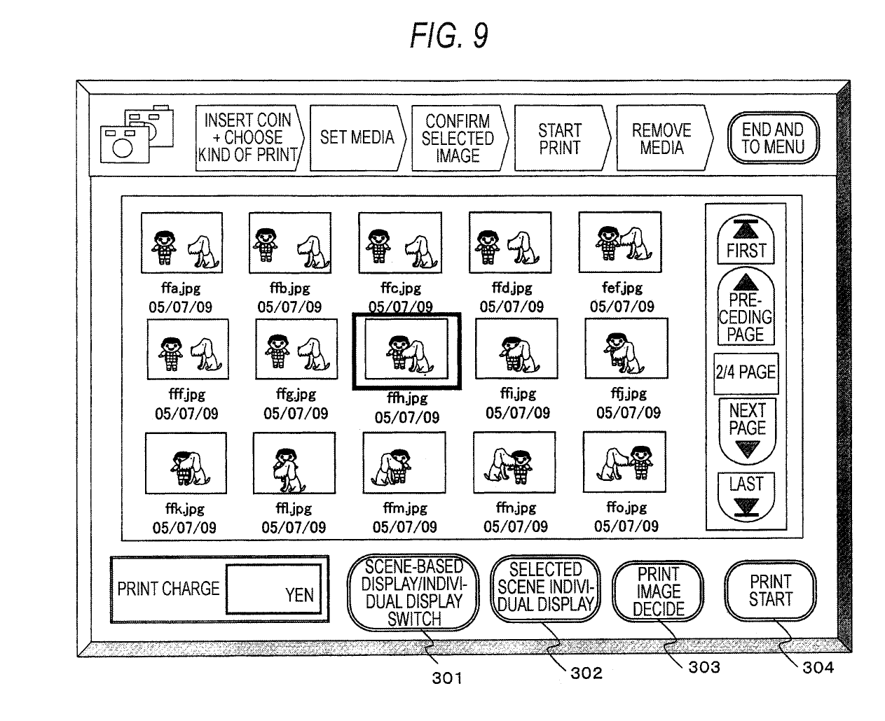

In addition, when the user selects a specific image “fff.jpg” from the list display data of the individual photographs included in the group (bundle) “fff.jpg” and operates the “print image decide” button 303 and the “print start” button 304 as shown in FIG. 9, the selected image “ffh.jpg” can be printed. When the user further operates the “scene-based display/individual display switch” button 301, the display can be switched to scene-based display information shown in FIG. 6 again.

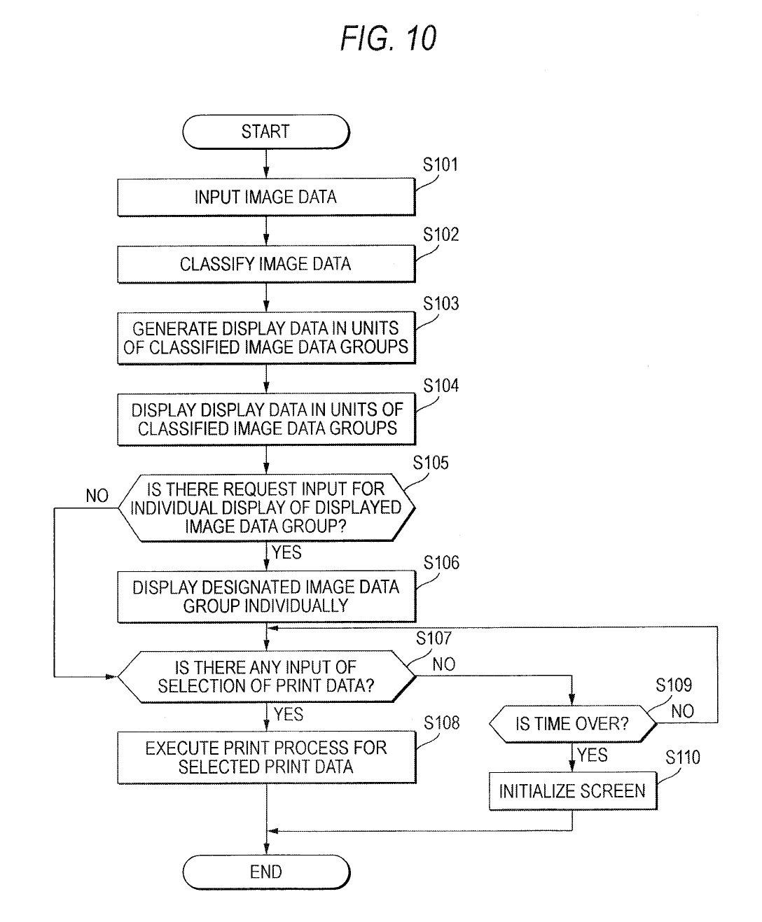

Next, a processing sequence executed by the information processing apparatus 200 according to the exemplary embodiment of the invention will be described with reference to a flow chart shown in FIG. 10. First, in Step S101, image data to be displayed as a list of images are input. The image data are input from a medium 150 set in the data input section (media slot) 202 shown in FIG. 2 or from the storage section 201 such as a hard disk, etc. For example, the input image data are of the Exif file format as described above with reference to FIG. 3.

In Step S102, the data processing section 203 classifies the plural pieces of image data. That is, the data processing section 203 classifies the plural images by judging as to whether or not each image is included in a photograph group for one and the same scene. Specifically, the data processing section 203 classifies the images based on nearness in photographing dates and times included in attribute information or based on similarity in photographing conditions (exposure conditions, focal lengths, etc.) included in the attribute information or by using a process of judging from image analysis whether or not the images are a similar image.

In Step S103, the display information generating section 204 generates display information based on the image data classified by the data processing section 203. The display information generating section 204 generates list display data of thumbnail images. As described above with reference to FIGS. 5(1) and 5(2), the display mode for photographs to be displayed as respective representative photographs of scenes is different from the display mode for single photographs in order to explicitly indicate that each representative photograph belongs to a bundle of photographs. For example, the display information generating section may set the display mode of the representative photograph to be a display mode for stacking images behind the representative photograph, a display mode for attaching a folder mark to the representative photograph, a display mode for surrounding the representative photograph by lines so as to indicate a group of photographs, or a display mode for displaying a specific background image.

In Step S104, the display information generated by the display information generating section 204 is displayed on the display section 205. For example, the display information is display data shown in FIG. 6. In Step S105, the data processing section judges as to whether or not there is a request input for individual display of the displayed image data group. That is, the data processing section 203 judges as to whether the “selected scene individual display” button 302, which is described above with reference to FIG. 7, is operated. When the “selected scene individual display” button 302 is not operated, the routine of process proceeds to Step S107.

When the data processing section 203 detects that the “selected scene individual display” button 302 is operated, the data processing section 203 and the display information generating section 204 separate the designated group (bundle) of photographs into individual photographs and display a list of the individual photographs included in the designated group (bundle). That is, as described above with reference to FIG. 8, the individual photographs included in the group (bundle) “fff.jpg” are displayed as a list. The display page can be turned so that all the images included in the set (bundle) can be displayed sequentially.

In Step S107, the information processing apparatus 200 waits for an input of selection of print data. In step S108, the selected data is printed in accordance with the input. The data processing section 203 shown in FIG. 2 outputs a print instruction to the print control section 207 based on the input information from the user input section 206, so that printing of the designated image is executed.

When user's selection decision is not input in Step S107 but time-over is judged in Step S109, the routine of process goes to an initial screen in Step S110. Then, the process is terminated.

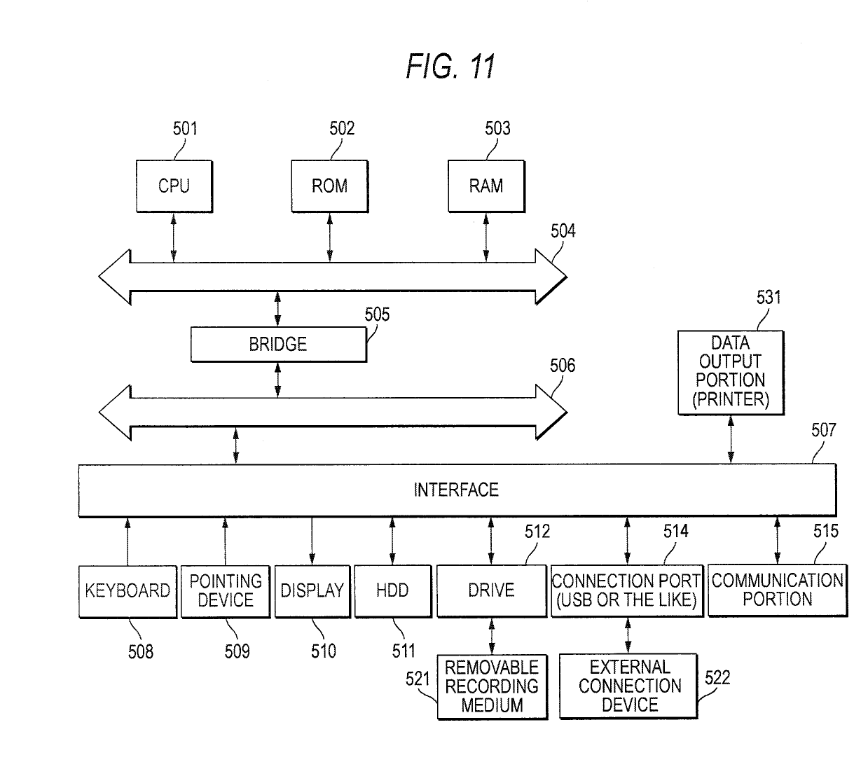

Finally, a hardware configuration example of the information processing apparatus for executing the aforementioned process will be described with reference to FIG. 11. The configuration shown in FIG. 11 is a hardware configuration of an information processing apparatus formed from a PC, etc., and having a data output portion 531 such as a printer.

A CPU (Central Processing Unit) 501 is a control portion for executing processing in accordance with a computer program in which an execution sequence of various kinds of data processing described in the aforementioned embodiment is written, that is, an execution sequence of processes such as a data classification process, a display data generating process, a display switching process, a print control process, etc. is written.

An ROM (Read Only Memory) 502 stores programs, operational parameters, etc. to be used by the CPU 501. An RAM (Random Access Memory) 503 stores programs to be used in execution of the CPU 501, and parameters changed appropriately in the execution. The ROM 502 and the RAM 503 are connected to each other by a host bus 504 formed from a CPU bus, etc.

The host bus 504 is connected to an external bus 506 such as a PCI (Peripheral Component Interconnect/Interface) bus through a bridge 505.

A keyboard 508 and a pointing device 509 are input devices to be operated by the user. A display 510 includes a liquid crystal display device, a CRT (Cathode Ray Tube), etc. The display 510 displays various kinds of information as text or image information.

An HDD (Hard Disk Drive) 511 has a built-in hard disk. The HDD 511 drives the hard disk to record or play back the programs or information to be executed by the CPU 501. Image data files to be displayed as a list and various computer programs such as various data processing programs are stored in the hard disk.

A drive 512 reads data or a program recorded in a removable recording medium 521 such as a magnetic disc, an optical disc, a magneto-optical disc or a semiconductor memory which is mounted in the drive 512, and supplies the data or program to the RAM 503 connected to the drive 512 through an interface 507, the external bus 506, the bridge 505 and the host bus 504. The removable recoding medium 521 can be also used as a data recording area similar to that in the hard disk.

A connection port 514 is a port for connecting an external connection device 522. The connection port 514 includes connection portions for USB, IEEE1394, etc. The connection port 514 is connected to the CPU 501, etc. through the interface 507, the external device 506, the bridge 505, the host bus 504, etc. A communication portion 515 is connected to a network in order to execute a data communication process with the outside. The data output portion 531 executes a data print-out process.

Incidentally, in the hardware configuration example of the information processing apparatus shown in FIG. 11, one apparatus is shown. The information processing apparatus according to the invention is not limited to the configuration shown in FIG. 11 but maybe configured to be capable of executing the processes described in the aforementioned embodiment.

The invention has been described above in detail along with a specific embodiment. It is however obvious to those skilled in the art that changes or replacements may be made on the embodiment without departing from the gist of the invention. That is, the invention is disclosed in a way of illustration but should not be interpreted in a limited sense. To judge the gist of the invention, the scope of Claims should be taken into consideration.

A series of processes described in the specification can be executed by hardware, software or a combination configuration of the hardware and software. When the processes are executed by software, programs for recording the processing sequence can be executed after installed in a memory in a computer installed in exclusively used hardware, or the programs can be executed after installed in a general-purpose computer which can execute various processes.

For example, the programs can be recorded in advance in the hard disk or ROM (Read Only Memory) as a recording medium. Or the programs can be stored (recorded) temporarily or permanently in removable recording media such as a flexible disc, a CD-ROM (Compact Disc Read Only Memory), An MO (Magneto Optical) disc, a DVD (Digital Versatile Disc), a magnetic disc, a semiconductor memory, etc. Such a removable recording medium can be provided as so-called package software.

Not only can the programs be installed in a computer from the aforementioned removable recording media, but also the programs can be transmitted by wireless to the computer from a download site or transmitted by wire to the computer through a network such as an LAN (Local Area Network) or the Internet so that the computer can receive the thus transmitted programs and-install the programs in a recording medium such as a built-in hard disk.

Various processes described in the specification are executed in a time sequence as described above. In addition, the various processes may be executed in parallel or individually in accordance with the throughput of the apparatus executing the processes or necessity. In addition, the system in this specification is a logical aggregate structure of a plurality of apparatuses. The system in this specification is not limited to a system in which each constituent apparatus is, located in one and the same housing.

What is claimed is:

1. An information processing apparatus for displaying a list of pieces of image data, the apparatus comprising:
a data processing section that classifies the pieces of image data, which are to be displayed in the list, into image groups based on information contained in the respective pieces of image data;
a display information generating section that generates display information, which represents a list including a representative image of each image group, based on a result of the classification by the data processing section; and
a display section that outputs the display information generated by the display information generating section.

2. The apparatus according to claim 1, wherein:
the data processing section analyzes nearness among date and time information, which are included in the respective pieces of image data as attribute information, and
the data processing section classifies, into the same image group, plural pieces of image data among which time differences are within a threshold time period.

3. The apparatus according to claim 1, wherein:
the data processing section analyzes similarity among photographing condition information, which are included in the respective pieces of image data as attribute information, and
the data processing section classifies, into the same image group, plural pieces of image data among which similarity in terms of a photograph condition are within a predetermined similarity.

4. The apparatus according to claim 1, wherein:
the data processing section analyzes similarity among image information, which are included in the respective pieces of image data as attribute information, and
the data processing section classifies, into the same image group, plural pieces of image data among which similarity in terms of the image information are within a predetermined similarity.

5. An information processing apparatus for displaying a list of pieces of image data, the apparatus comprising:
a data processing section that classifies the pieces of image data, which are to be displayed in the list, into image groups based on information contained in the respective pieces of image data;
a display information generating section that generates display information, which represents a list including a representative image of each image group, based on a result of the classification by the data processing section; and
a display section that outputs the display information generated by the display information generating section, wherein:
the display information generating section generates the display information so that an image display mode for displaying each representative image of an image group including plural pieces of image data and an image display mode for displaying each representative image of an image group consisting of single piece of image data are different from each other, and
the display information generating section outputs the display information to the display section.

6. The apparatus according to claim 1, wherein:
the data processing section acquires respective pieces of image data included in one of the image groups in accordance with group selection information input by a user with respect to the display data in which only the representative image selected from each image group is set as an image to be displayed; and
the display information generating section generates an image list including respective images included in the selected one of the image groups and outputs the image list to the display section.

7. An information processing method for displaying a list of pieces of image data, the method comprising:
classifying the pieces of image data, which are to be displayed in the list, into image groups based on information contained in the respective pieces of image data;
generating display information, which represents a list including a representative image of each image group, based on data result of the classification; and
outputting the generated display information.

8. The method according to claim 7, wherein:
the classifying of the image data comprises:
analyzing nearness among date and time information, which are included in the respective pieces of image data as attribute information; and
classifying, into the same image group, plural pieces of image data among which time differences are within a threshold time period.

9. The method according to claim 7, wherein:
the classifying of the image data comprises:
analyzing similarity among photographing condition information, which are included in the respective pieces of image data as attribute information; and
classifying, into the same image group, plural pieces of image data among which similarity in terms of a photograph condition are within a predetermined similarity.

10. The method according to claim 7, wherein:
the classifying of the image data comprises:
analyzing similarity among image information, which are included in the respective pieces of image data as attribute information; and
classifying, into-the same image group, plural pieces of image data among which similarity in terms of the image information are within a predetermined similarity.

11. The method according to claim 7, wherein:
the generating of the display information generates the display information so that an image display mode for displaying each representative image of an image group including plural pieces of image data and an image display mode for displaying each representative image of an image group consisting of single piece of image data are different from each other.

12. The method according to claim 7, further comprising:
acquiring respective pieces of image data included in one of the image groups in accordance with group selection information input by a user with respect to the display data in which only the representative image selected from each image group is set as an image to be displayed, wherein:
the generating of the display information comprises generating an image list including respective images included in the selected one of the image groups.

13. A computer readable medium storing a program causing a computer to perform a process for displaying a list of pieces of image data, the process comprising:
classifying the pieces of image data, which are to be displayed in the list, into image groups based on information contained in the respective pieces of image data;
generating display information, which represents a list including a representative image of each image group, based on data result of the classification; and
outputting the generated display information.

14. A computer data signal embodied in a carrier wave for enabling a computer to perform a process for displaying a list of pieces of image data, the process comprising:
classifying the pieces of image data, which are to be displayed in the list, into image groups based on information contained in the respective pieces of image data;
generating display information, which represents a list including a representative image of each image group, based on data result of the classification; and
outputting the generated display information.
